(19) United States
(12) Patent Application Publication
(10) Pub. No.: US 2018/0322851 A1
(43) Pub. Date: Nov. 8, 2018

(54) WOODWIND INSTRUMENT REED AND METHOD FOR PRODUCING WOODWIND INSTRUMENT REED

(71) Applicant: YAMAHA CORPORATION, Hamamatsu-shi (JP)

(72) Inventor: Eiji ABE, Iwata-shi (JP)

(21) Appl. No.: 16/039,593

(22) Filed: Jul. 19, 2018

Related U.S. Application Data
(63) Continuation of application No. PCT/JP2016/081781, filed on Oct. 26, 2016.

(30) Foreign Application Priority Data
Jan. 26, 2016 (JP) 2016-012534
May 23, 2016 (JP) 2016-102876

(51) Int. Cl. G10D 9/02

(52) U.S. Cl. CPC G10D 9/023

(57) ABSTRACT

A woodwind instrument reed is strip-shaped and has a vamp on one side in a longitudinal direction. The reed includes a resin matrix containing a liquid crystal polymer as a principal component, and a layered mineral dispersed in the resin matrix. A method for producing a woodwind instrument reed that is strip-shaped and has a vamp on one side in a longitudinal direction includes charging a composition for forming the reed into a cavity of a mold from a longitudinal end on a side opposite to the vamp to be formed. The composition contains a liquid crystal polymer as a principal component, and a layered mineral.

### BACKGROUND OF THE INVENTION

### Field of the Invention

The present invention relates to a woodwind instrument reed and a method for producing a woodwind instrument reed.

### Description of the Related Art

Sound on a woodwind instrument such as a saxophone or a clarinet is produced in such a manner that a player blows into a mouthpiece to vibrate a strip-shaped reed attached to the mouthpiece. Woodwind instrument reeds are typically formed from natural materials such as phragmites (generally referred to as common reed). Each reed has a vamp provided by shaving the surface of the reed such that the thickness of the reed gradually decreases to the longitudinal end that is to be held in the mouth of the player.

A drawback of woodwind instrument reeds formed from a natural material is great variability among individual reeds. Thus, even users who are inexperienced players at a relatively lower level of proficiency usually select, from among reeds in stock, reeds that allow satisfactory tone quality to be produced, whereas the rest of reeds that would not allow satisfactory tone quality to be produced is discarded. Specifically, woodwind instrument reeds mostly come in a set of ten, and even an ordinary user having purchased such a set of ten reeds often decides that only about two or three of them are usable.

Meanwhile, woodwind instrument reeds inevitably come into contact with moisture contained in saliva and breath of the player. Such a woodwind instrument reed formed from phragmites or bamboo increasingly deteriorates due to the contact with moisture, and thus it is disadvantageous in that its useful life is relatively short. In view of overcoming the disadvantage, reeds formed from a synthetic resin and superior in durability have been proposed. Specifically, a woodwind instrument reed formed from a liquid crystal polymer has been proposed in Japanese Unexamined Patent Application, Publication No. 2001-75556.

### PRIOR ART DOCUMENT

### Patent Document

Patent Document 1: Japanese Unexamined Patent Application, Publication No. 2001-75556

### SUMMARY OF THE INVENTION

### Problems to be Solved by the Invention

Such a woodwind instrument reed disclosed in the aforementioned publication is commonly formed by injection molding, which includes charging a composition for forming the reed into a cavity of a mold and hardening the composition in the cavity. As a result of thorough investigation, the present inventor found it difficult to sufficiently reduce the thickness of the tip of the vamp when forming a reed by injection molding through the use of the liquid crystal polymer. The failure to sufficiently reduce the thickness of the tip of the vamp in the formation of the reed by injection molding through the use of the liquid crystal polymer leads to insufficient flexibility of the vamp, and it was also found that the use of the resultant reed gave lower sound quality than would have been possible by using a woodwind instrument reed formed from a natural material.

The present invention was made in view of the foregoing circumstances, and an object of the present invention is to provide: a reed for a woodwind instrument which enables a reduction in the thickness of the tip of a vamp even through the use of a liquid crystal polymer, and accordingly enables the vamp to have enhanced flexibility; and a method for producing a woodwind instrument reed.

### Means for Solving the Problems

An aspect of the present invention made for solving the aforementioned problems is a woodwind instrument reed that is strip-shaped and has a vamp on one side in a longitudinal direction. The woodwind instrument reed includes a resin matrix containing a liquid crystal polymer as a principal component, and a layered mineral dispersed in the resin matrix.

Another aspect of the present invention made for solving the aforementioned problems is a method for producing a woodwind instrument reed that is strip-shaped and has a vamp on one side in a longitudinal direction. The method includes charging a composition for forming the reed into a cavity of a mold from a longitudinal end on a side opposite to the vamp to be formed. The composition contains a liquid crystal polymer as a principal component, and a layered mineral.

### Effects of the Invention

The present inventor thoroughly investigated the formation of a woodwind instrument reed by, for example, injection molding through the use of a liquid crystal polymer, and found it difficult to charge the liquid crystal polymer into the tip of a cavity of a mold because the liquid crystal polymer was crystallized before reaching a thin portion of the cavity (the longitudinal tip portion where a vamp is to be formed). The present inventor also found that the liquid crystal polymer having such an insufficient filling property made it difficult to form a vamp having a thin tip, and that the formed vamp was not sufficiently flexible accordingly. In contrast, the resin matrix of the woodwind instrument reed according to the aspect of the present invention contains, in addition to the liquid crystal polymer being a principal component, the layered mineral dispersed in the resin matrix. This constitution enables the liquid crystal polymer to exhibit an improved filling property in the cavity, thereby allowing the liquid crystal polymer to be charged even into the tip of the cavity. This enables a reduction in the thickness of the vamp (the tip portion of the vamp, in particular) of the woodwind instrument reed, thereby enhancing the flexibility of the vamp.

According to the method for producing a woodwind instrument reed of the another aspect of the present invention, the composition for forming the reed contains the layered mineral in addition to the liquid crystal polymer being a principal component, and the liquid crystal polymer is thus allowed to be charged into the tip of the cavity where the vamp is to be formed when the composition for forming the reed is charged into the cavity of the mold from the longitudinal end on the side opposite to the vamp to be formed. Therefore, the method for producing a woodwind instrument reed enables formation of the vamp having a reduced thickness (at the tip portion of the vamp, in particular), thereby enhancing the flexibility of the vamp.

It is to be noted that the term “principal component” as referred to herein means a component contained in the highest proportion, and refers to a component present in a proportion of, for example, 50% by mass or more, preferably 70% by mass or more, and more preferably 80% by mass or more. The term “mean particle diameter” as referred to herein means a particle diameter represented by 50% (D50) on the volumetric particle size distribution curve as measured by laser diffraction. The expression “the liquid crystal polymer is oriented in the longitudinal direction” herein means the state in which the orientation angle of the liquid crystal polymer with respect to the longitudinal direction is ±5° or less, and preferably ±3° or less. The expression “miscible with” herein means that no phase separation is observed when a mixture in a molten state is examined with a transmission electron microscope at a magnification of 15,000.

### BRIEF DESCRIPTION OF THE DRAWINGS

FIG. 1 is a schematic perspective view of a saxophone to which a woodwind instrument reed according to an embodiment of the present invention is attached;

FIG. 2 is a schematic cross-sectional side view of a mouthpiece of the saxophone shown in FIG. 1;

FIG. 3 is a schematic plan view of the woodwind instrument reed for the saxophone shown in FIG. 1;

FIG. 4 is a schematic side view of the woodwind instrument reed shown in FIG. 3;

FIG. 5 is a schematic partial cross-sectional view for describing an apparatus for producing the woodwind instrument reed shown in FIG. 3;

FIG. 6 is a photographed image of a plane surface of the No. 1 woodwind instrument reed;

FIG. 7 is a photographed image of a plane surface of the No. 2 woodwind instrument reed;

FIG. 8 is a photographed image of a plane surface of the No. 3 woodwind instrument reed;

FIG. 9 is a photographed image of a plane surface of the No. 4 woodwind instrument reed;

FIG. 10 is a photographed image of a plane surface of the No. 5 woodwind instrument reed;

FIG. 11 is a graph showing vibration modes of Nos. 1, 2, 4 and 5; and

FIG. 12 is a graph showing elastic modulus in flexure of each of the Nos. 8, 9, and 11 to 14 woodwind instrument reeds.

### DESCRIPTION OF THE EMBODIMENTS

Embodiments of the present invention will be described below in detail, with appropriate reference to the drawings.

### First Embodiment

Saxophone

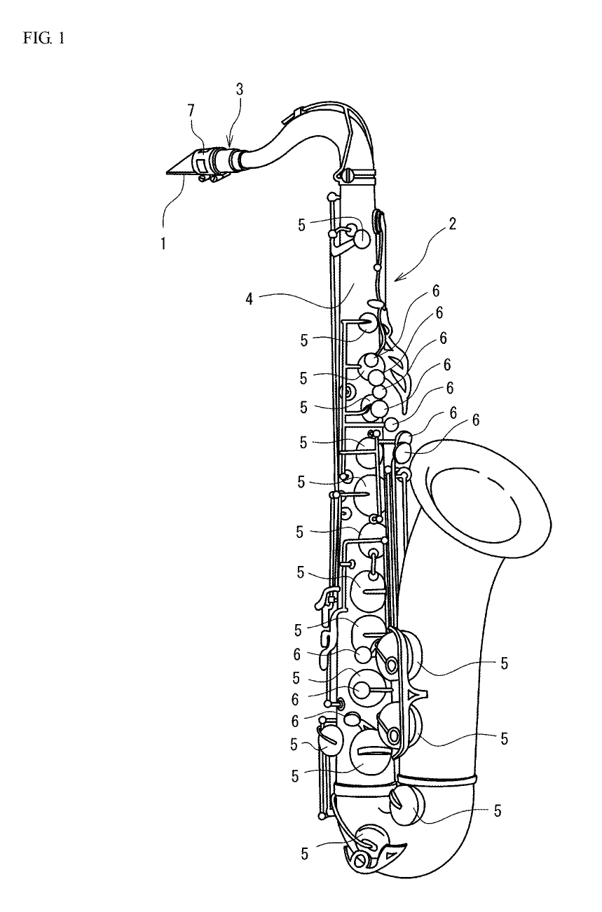

FIG. 1 illustrates a saxophone, which is a kind of woodwind instruments to be provided with a woodwind instrument reed 1 according to an embodiment of the present invention.

The saxophone shown in FIG. 1 is configured in such a manner that a mouthpiece 3 having the woodwind instrument reed 1 attached thereto is fitted in one end of a saxophone body 2.

The saxophone body 2 includes: a pipe part 4 that is U-bent, with one end to be connected to the mouthpiece 3 and the other end being open and flared out; keys 5 disposed in a manner to be able to stop tone holes formed in the pipe part 4; and levers 6 to be used to control the keys 5. The configuration of the saxophone body 2 may be similar to the configuration of a conventional saxophone body.

The mouthpiece 3 is fitted in the one end of the saxophone body 2 and is used such that the player can blow into the saxophone body 2 to vibrate the woodwind instrument reed 1.

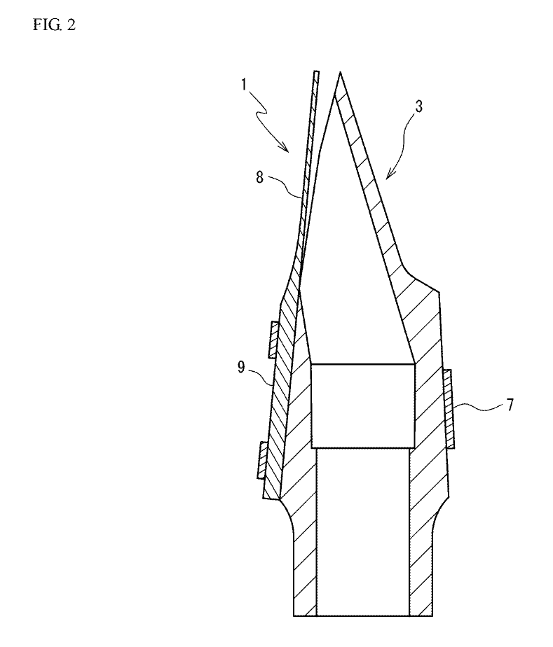

As shown in FIG. 2, the mouthpiece 3 is formed into an approximately tubular shape, with one end to be held in the mouth of the player being flattened as if the one end had been pressed. The mouthpiece 3 has a wide opening on the side to come into contact with the lower lip of the player. The woodwind instrument reed 1 is attached to the mouthpiece 3 to cover the opening. The woodwind instrument reed 1 is fixed to the mouthpiece 3 with a ligature 7 fitted to the outer periphery of the mouthpiece 3. A mouthpiece and a ligature having conventional configurations may be respectively used as the mouthpiece 3 and the ligature 7.

Woodwind Instrument Reed

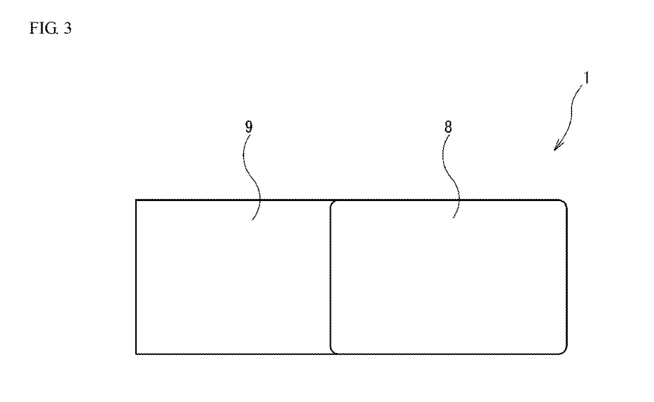

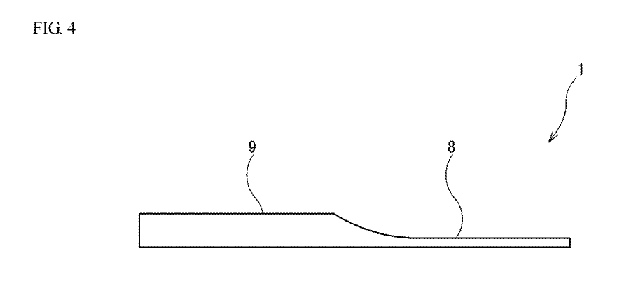

The following describes the woodwind instrument reed 1 with reference to FIGS. 3 and 4. The woodwind instrument reed 1 is formed into a strip shape and has a vamp 8 on one side in a longitudinal direction. The woodwind instrument reed 1 has a front face 9 of the part where the vamp 8 is not formed (the face opposite to the face to which the mouthpiece 3 is fitted), and the front face 9 is curved as if it is part of a cylindrical surface. The curved surface has a longitudinal axis parallel to the back face (the face to which the mouthpiece 3 is fitted) and protrudes toward the front face side. As shown in FIGS. 1 and 2, the part of the woodwind instrument reed 1 where the vamp 8 is not formed is fastened to the mouthpiece 3 with the ligature 7, which accordingly holds the woodwind instrument reed 1 and the mouthpiece 3 as integral parts such that the front face of the woodwind instrument reed 1 is continuous with the external surface of the mouthpiece 3.

The vamp 8 is formed in such a manner that the woodwind instrument reed 1 gradually decreases in thickness to the longitudinal end that is to be held in the mouth of the player (hereinafter, may be merely referred to as a “tip”). Specifically, the vamp 8 is typically curved such that the inclination is greater at a position closer to the heel of the woodwind instrument reed 1 (the longitudinal end on the side where the vamp 8 is not formed), and that the tip portion of the vamp 8 extends in an approximately planar manner. The curved shape of the vamp 8 is similar to the curved shape of a vamp of a conventional reed.

The average length of the vamp 8 in the longitudinal direction is preferably 20 mm or more and 30 mm or less. Even in the case where the average length of the vamp 8 in the longitudinal direction is within the above range, the liquid crystal polymer that exhibits the improved filling property enables a sufficient reduction in the thickness of the tip portion of the vamp 8 of the woodwind instrument reed 1. The tip portion of the vamp 8 has enhanced flexibility accordingly, and the woodwind instrument reed 1 in turn enables an improvement in the comfort of the player and in sound quality during a performance.

The lower limit of the average thickness of the tip of the vamp 8 is preferably 0.08 mm, and more preferably 0.1 mm. The upper limit of the average thickness of the tip of the vamp 8 is preferably 0.14 mm, and more preferably 0.12 mm. The liquid crystal polymer that exhibits the improved filling property enables formation of the woodwind instrument reed 1 including the vamp 8 the tip of which has a thickness small enough to fall within the above range. The tip portion of the vamp 8 has enhanced flexibility accordingly, and the woodwind instrument reed 1 in turn enables the improvement in the comfort of the player and in sound quality during a performance. The term “average thickness of the tip of the vamp” as referred to herein means a value obtained by averaging the thicknesses at randomly chosen three points on the tip edge of the vamp.

The schematic shape of the woodwind instrument reed 1 is similar to the schematic shape of a conventional reed formed from, for example, phragmites. The average width of the woodwind instrument reed 1 may be, for example, 10 mm or more and 20 mm or less. The maximum thickness of the part of the woodwind instrument reed 1 where the vamp 8 is not formed may be, for example 2.5 mm or more and 4 mm or less. The dimensions of the woodwind instrument reed 1 are not limited to the above ranges, and may be changed as appropriate depending on the type of woodwind instruments to which the woodwind instrument reed 1 is to be attached.

The woodwind instrument reed 1 contains a resin matrix containing a liquid crystal polymer as a principal component, and a layered mineral dispersed in the resin matrix. The liquid crystal polymer is not limited as long as it has a liquid crystalline nature. Examples of the liquid crystal polymer include thermotropic liquid crystal polymers having structural units as represented by the following formulae (1) to (3).

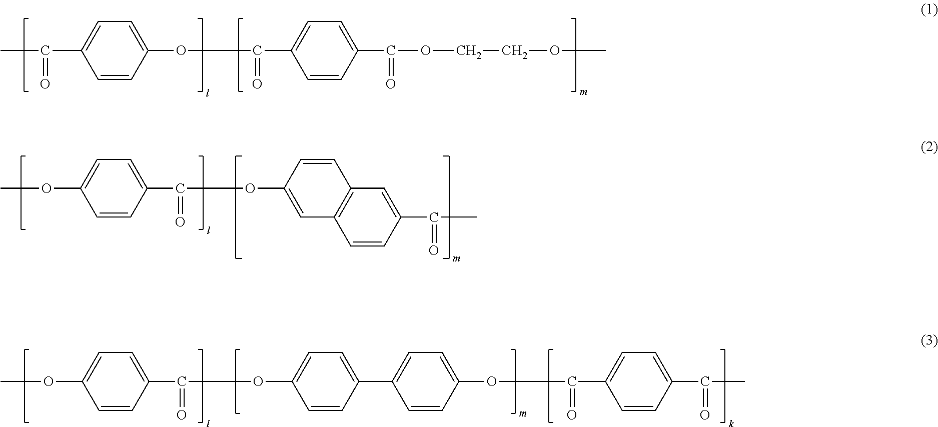

In the above formulae (1), (2) and (3), l, m and k each represent the number of the structural units in the thermotropic polymer.

Examples of the layered mineral include talc, hydroxyapatite, diatomaceous earth, and the like. Since the woodwind instrument reed 1 contains the layered mineral, enhancement of the surface glossiness of the woodwind instrument reed 1 is enabled while the liquid crystal polymer exhibits the improved filling property in the cavity and has improved orientation. Of these minerals, talc is preferred as the layered mineral. Talc as the layered mineral enables the liquid crystal polymer to exhibit the improved filling property in the vamp easily without fail. Therefore, formation of a thin vamp (a vamp having a thin tip portion, in particular) is enabled, and the flexibility of the vamp is easily improved.

The lower limit of the mean particle diameter of the layered mineral is preferably 2 μm, more preferably 3 μm, still more preferably 5 μm, and particularly preferably 8 μm. The upper limit of the mean particle diameter of the layered mineral is preferably 20 μm, and more preferably 15 μm. In the case where the mean particle diameter of the layered mineral is less than the lower limit, the layered mineral may have poor dispersibility. Conversely, in the case where the mean particle diameter of the layered mineral is greater than the upper limit, the composition that is for forming a reed and contains the liquid crystal polymer as a principal component may become too viscous, and consequently, the liquid crystal polymer may not be sufficiently charged into the tip portion of the cavity.

The shape of the layered mineral is not limited, but the layered mineral is preferably flaky. In the case where the layered mineral is flaky, the liquid crystal polymer in the cavity exhibits enhanced slipping property, making it easy to charge the liquid crystal polymer into the tip portion of the cavity. The expression “flaky” herein means thin and flat.

The lower limit of the average aspect ratio of the layered mineral is preferably 3, and more preferably 5. In the case where the average aspect ratio of the layered mineral is less than the lower limit, the layered mineral may fail to sufficiently improve the slipping property of the liquid crystal polymer in the cavity. The upper limit of the average aspect ratio of the layered mineral may be, for example, 20, but is not limited thereto. The term “aspect ratio” as referred to herein means the ratio of the maximum diameter to the minimum diameter. The term “average aspect ratio” as referred to herein means a value obtained by averaging the aspect ratios of randomly chosen 20 pieces of talc.

The lower limit of the content of the layered mineral is preferably 1% by mass, and more preferably 2% by mass. The upper limit of the content of the layered mineral is preferably 7% by mass, more preferably 6% by mass, still more preferably 5% by mass, and particularly preferably 4% by mass. In the case where the content of the layered mineral is less than the lower limit, the liquid crystal polymer may fail to exhibit a sufficient slipping property in the cavity, and consequently, the liquid crystal polymer may not be sufficiently charged into the tip portion of the cavity. Conversely, in the case where the content of the layered mineral is greater than the upper limit, the liquid crystal polymer may have a low degree of orientation and the tip may be brittle and breakable.

The liquid crystal polymer contained in the woodwind instrument reed 1 is preferably oriented in the longitudinal direction. The liquid crystal polymer oriented in the longitudinal direction imparts further enhanced flexibility to the woodwind instrument reed 1, thereby enabling a further improvement in quality.

According to the woodwind instrument reed 1 of the embodiment of the present invention, since the filling property of the liquid crystal polymer in the cavity is enhanced, the liquid crystal polymer can be prevented from being crystallized before reaching the tip portion of the cavity. Consequently, the liquid crystal polymer is crystallized after reaching the tip of the cavity and therefore, the longitudinal orientation of the liquid crystal polymer is enabled even in the tip portion of the vamp 8 of the woodwind instrument reed 1. Specifically, it is preferred that the liquid crystal polymer is oriented in the longitudinal direction over the entire area except for the region up to 30 mm in the longitudinal direction from the tip of the vamp 8. It is more preferred that the liquid crystal polymer is oriented in the longitudinal direction over the entire area except for the region up to 0.1 mm in the longitudinal direction from the tip of the vamp 8. The liquid crystal polymer oriented in the longitudinal direction even in the tip portion of the vamp 8 enables an improvement in the flexibility of the entirety of the woodwind instrument reed 1 in the longitudinal direction, thereby enabling a further improvement in quality.

As long as the matrix contains the liquid crystal polymer as a principal component, the matrix may further contain other synthetic resins. The woodwind instrument reed 1 may contain additives other than the layered mineral.

### Method for Producing Woodwind Instrument Reed

The following describes the method for producing a woodwind instrument reed 1 according to the embodiment of the present invention. The method for producing a woodwind instrument reed may be implemented by using an injection molding apparatus 11 shown in FIG. 5. First, the injection molding apparatus 11 will be described below.

Injection Molding Apparatus

The injection molding apparatus 11 includes a cylinder 15 having a nozzle 16 at the tip thereof; a hopper 14 connected to the cylinder 15; and a screw 17 installed in the cylinder 15. The injection molding apparatus 11 includes a mold 12 having a cavity 13 formed therein. The cavity 13 communicates with the opening of the nozzle 16 through a sprue, a runner, a gate, etc. The injection molding apparatus 11 is configured to feed a composition for forming the reed in the hopper 14 into the cylinder 15 through an inlet 14a of the hopper 14, and to charge the composition into the cavity 13 of the mold 12 through the opening of the nozzle 16. The gate of the injection molding apparatus 11 is as a side gate. The injection molding apparatus 11 is configured to charge, through the side gate, the composition for forming the reed into the cavity 13 of the mold 12 from the side opposite to the vamp 8 to be formed. (The injection molding apparatus 11 shown in FIG. 5 is configured to charge the composition for forming the reed into the cavity 13 of the mold 12, thereby forming two woodwind instrument reeds 1.)

The method for producing a woodwind instrument reed includes: charging a composition for forming the reed into the cavity 13 of the mold 12 from the a longitudinal end on the side opposite to the vamp 8 to be formed (charging step), the composition containing the liquid crystal polymer as a principal component and the layered mineral; and hardening the charged composition for forming the reed in the cavity 13 (hardening step).

Charging Step

In the charging step, the composition for forming the reed is charged into the hopper 14 of the injection molding apparatus 11. Then, the composition for forming the reed is injected into the cavity 13 of the mold 12 through the cylinder 15 while being in a molten state. Specifically, the hopper 14 is connected to a part of the cylinder 15 posterior to the center in the longitudinal direction of the cylinder 15 (on the side opposite to the mold 12). The composition for forming the reed fed from the hopper 14 is injected from the cylinder 15 through the nozzle 16 provided at the end of the cylinder 15 on the mold 12 side. The method for producing a woodwind instrument reed involves charging the composition for forming the reed into the cavity 13 of the mold 12 from the longitudinal end on the side opposite to the vamp 8 to be formed, thereby yielding the longitudinal orientation of the liquid crystal polymer in the woodwind instrument reed.

The lower limit of the nozzle temperature in the charging step is preferably 250° C., more preferably 270° C., and still more preferably 290° C. The upper limit of the nozzle temperature is preferably 350° C., more preferably 330° C., and still more preferably 310° C. In the case where the nozzle temperature is less than the lower limit, it may be difficult to charge the liquid crystal polymer into the tip of the cavity 13 of the mold 12 where the vamp 8 is to be formed. Conversely, in the case where the nozzle temperature is greater than the upper limit, the liquid crystal polymer may deteriorate, leading to poor formability of the woodwind instrument reed. The expression “nozzle temperature” herein means the temperature of the inner surface of the nozzle as measure by using a thermocouple.

It is preferred that the temperature in the cylinder 15 gradually increases from a rear part Z (on the side opposite to the nozzle 16) to a front part X (on the nozzle 16 side). The gradual increases in the temperature in the cylinder 15 from the rear part Z to the front part X prevent backflow of the composition for forming the reed in the cylinder 15, enabling effective improvement in the filing property of the composition for forming the reed in the cavity 13. The gradual increases in the temperature in the cylinder 15 from the rear part Z to the front part X also prevent unnecessary heating of the composition for forming the reed, thus enabling prevention of deterioration of the liquid crystal polymer.

The lower limit of the temperature in the rear part Z of the cylinder 15 in the charging step is preferably 160° C., more preferably 170° C., and still more preferably 180° C. The upper limit of the temperature in the rear part Z is preferably 220° C., more preferably 210° C., and still more preferably 200° C. In the case where the temperature in the rear part Z is less than the lower limit, the composition for forming the reed in the cylinder 15 may not be sufficiently fluid. In the case where the temperature in the rear part Z is less than the lower limit, the composition for forming the reed fed from the hopper 14 into the cylinder 15 may not be sufficiently heated. Conversely, in the case where the temperature in the rear part Z is greater than the upper limit, the composition for forming the reed may flow back in the cylinder 15. Furthermore, in the case where the temperature in the rear part Z is greater than the upper limit, the composition for forming the reed may be overheated, and the liquid crystal polymer may deteriorate accordingly. The expression “temperature in the rear part Z of the cylinder” herein means the temperature of the composition for forming the reed in the rear part Z of the cylinder as measured by using a thermocouple. The “rear part Z” herein means a joint and the vicinity thereof, between the cylinder 15 and the hopper 14 and the vicinity of the joint.

The lower limit of the temperature in the intermediate part between the rear part Z and the front part X of the cylinder 15 (hereinafter, may be merely referred to as “intermediate part Y”) in the charging step is preferably 230° C., more preferably 250° C., and still more preferably 270° C. The upper limit of the temperature in the intermediate part Y is preferably 310° C., more preferably 300° C., and still more preferably 290° C. In the case where the temperature in the intermediate part Y is less than the lower limit, the composition for forming the reed in the cylinder 15 may not be sufficiently fluid. Furthermore, in the case where the temperature in the intermediate part Y is less than the lower limit, the composition for forming the reed fed from the hopper 14 into the cylinder 15 may not be sufficiently heated. Conversely, in the case where the temperature in the intermediate part Y is greater than the upper limit, the composition for forming the reed may flow back in the cylinder 15. Furthermore, in the case where the temperature in the intermediate part Y is greater than the upper limit, the composition for forming the reed may be overheated, and the liquid crystal polymer may deteriorate accordingly. The expression “the temperature in the intermediate part Y of the cylinder” herein means the temperature of the composition for forming the reed in the intermediate part Y of the cylinder as measured by using a thermocouple. The “intermediate part Y” herein means the midpoint and the vicinity thereof, between the rear end of the nozzle 16 and the joint where the cylinder 15 and the hopper 14 is connected.

The temperature in the front part X of the cylinder 15 in the charging step may be equivalent to the nozzle temperature. In the case where temperature in the front part X is equivalent to the nozzle temperature, an effective improvement in the filling property of the composition for forming the reed in the cavity 13 is enabled while the liquid crystal polymer is prevented from deteriorating. The expression “the temperature in the front part X of the cylinder” herein means the temperature of the composition for forming the reed in the front part X of the cylinder as measured by using a thermocouple. The “front part X” herein means the rear end and the vicinity thereof, of the nozzle 16.

The lower limit of the temperature of the inlet 14a of the hopper 14 is preferably 50° C., more preferably 60° C., and still more preferably 65° C. The upper limit of the temperature at the inlet 14a of the hopper 14 is preferably 100° C., more preferably 90° C., and still more preferably 80° C. In the hopper 14, the composition for forming the reed is maintained in the form of pellet. Thus, in the case where the temperature at the inlet 14a of the hopper 14 is less than the lower limit, the liquid crystal polymer fed into the cylinder 15 may not be easily molten with speed in the cylinder 15, and consequently, the composition for forming the reed in the cylinder 15 may not be sufficiently fluid. Conversely, in the case where the temperature at the inlet 14a of the hopper 14 is greater than the upper limit, it may be difficult to maintain the composition for forming the reed in the form of pellet in the hopper 14. The expression “the temperature at the inlet of the hopper” herein means the temperature of the inner surface of the inlet of the hopper as measured by a temperature sensor.

The lower limit of the temperature in the cavity 13 in the charging step is preferably 50° C., more preferably 60° C., and still more preferably 65° C. The upper limit of the temperature in the cavity 13 is preferably 100° C., more preferably 90° C., and still more preferably 80° C. In the case where the temperature in the cavity 13 is less than the lower limit, the liquid crystal polymer may be insufficiently fluid in the cavity 13. Consequently, it may be difficult to charge the liquid crystal polymer into the tip of the cavity 13 where the vamp 8 is to be formed. Conversely, in the case where the temperature in the cavity 13 is greater than the upper limit, it may be difficult to sufficiently cool the composition for forming the reed in the cavity 13 in the hardening step, which will be described below. Consequently, it may be difficult to release the composition for forming the reed from the cavity 13 in a stable manner while keeping the shape of the composition.

The lower limit of the injection speed in the charging step is preferably 120 mm/s, more preferably 130 mm/s, and still more preferably 140 mm/s. The upper limit of the injection speed is preferably 250 mm/s, more preferably 200 mm/s, and still more preferably 170 mm/s. In the case where the injection speed is less than the lower limit, it may be difficult to charge the liquid crystal polymer into the tip of the cavity 13 where the vamp 8 is to be formed. Conversely, in the case where the injection speed is greater than the upper limit, it may be difficult to control the fluidity of the liquid crystal polymer in the cavity 13. In contrast, regulating the injection speed within the above range enables the liquid crystal polymer to be charged into the cavity 13 almost evenly and uniformly.

Hardening Step

In the hardening step, the cavity 13 is cooled such that the composition for forming the reed having been charged in the charging step is hardened. Specifically, the internal pressure of the cavity 13 is maintained for a certain period of time, and then the cavity 13 is cooled by a well-known method. The composition for forming the reed is hardened in the hardening step, and then the hardened composition for forming the reed is released from the cavity 13. The woodwind instrument reed 1 shown in FIG. 3 is thus obtained.

The lower limit of the time period over which the internal pressure of the cavity 13 is maintained in the hardening step is preferably 2 seconds, and more preferably 5 seconds. The upper limit of the pressure maintaining time period is preferably 30 seconds, and more preferably 20 seconds. In the case where the pressure maintaining time period is shorter than the lower limit, the composition for forming the reed may not be sufficiently charged into the cavity 13, making it difficult to form a woodwind instrument reed into a desired shape. Conversely, in the case where the pressure maintaining time period is longer than the upper limit, the cavity may be overcharged with the composition, resulting in formation of burrs.

The lower limit of the time period over which the cavity 13 is cooled in the hardening step is preferably 10 seconds, and more preferably 20 seconds. The upper limit of the cooling time is preferably 150 seconds, and more preferably 50 seconds. In the case where the cooling time is shorter than the lower limit, sufficient cooling may not be performed, and thus, the composition for forming the reed may not be sufficiently hardened. Conversely, in the case where the cooling time is longer than the upper limit, the unduly prolonged cooling may reduce the of woodwind instrument reeds. In contrast, regulating the cooling time within the above range allows the composition for forming the reed to be sufficiently hardened. This enables the composition for forming the reed to be released from the cavity 13 in a stable manner while keeping the shape of the composition.

### Advantages

The resin matrix of the woodwind instrument reed 1 of the embodiment of the present invention contains, in addition to the resin matrix containing the liquid crystal polymer being a principal component, the layered mineral dispersed in the resin matrix. This constitution enables improvement in the filling property of the liquid crystal polymer in the cavity 13, thereby allowing the liquid crystal polymer to be charged even into the tip of the cavity 13. This enables a reduction in the thickness in the vamp 8 (the tip portion of the vamp 8, in particular) of the woodwind instrument reed 1, thereby enhancing the flexibility of the vamp 8.

According to the method for producing a woodwind instrument reed of the embodiment of the present invention, the composition for forming the reed contains the layered mineral in addition to the liquid crystal polymer being a principal component, and the liquid crystal polymer is thus allowed to be charged into the tip of the cavity 13 where the vamp 8 is to be formed when the composition for forming the reed is charged into the cavity 13 of the mold 12 from the longitudinal end on the side opposite to the vamp 8 to be formed. Therefore, the method for producing a woodwind instrument reed enables formation of the vamp 8 having a reduced thickness (at the tip portion of the vamp 8, in particular), thereby enhancing the flexibility of the vamp 8.

### Second Embodiment

Woodwind Instrument Reed

Next, the woodwind instrument reed according to an embodiment of the present invention having a configuration different from that of the first embodiment will be described below. The woodwind instrument reed is formed into a strip shape and has a vamp on one side in a longitudinal direction. The specific shape of the woodwind instrument reed is schematically similar to that of the woodwind instrument reed 1 shown in FIGS. 3 and 4. The average length in the longitudinal direction of the vamp of the woodwind instrument reed and the average width of the woodwind instrument reed may be similar to those of the woodwind instrument reed 1 shown in FIGS. 3 and 4.

The average thickness of the tip of the vamp of the woodwind instrument reed according to the present embodiment may be similar to those of the woodwind instrument reed according to the first embodiment. Meanwhile, a thermoplastic resin, which will be described below, enables an improvement in the flexibility of the woodwind instrument reed according to the present embodiment, which is thus sufficiently flexible even in the case where the average thickness of the tip of the vamp is greater than the average thickness of the tip of the vamp of the woodwind instrument reed 1 according to the first embodiment. In this regard, the lower limit of the average thickness of the tip of the vamp of the woodwind instrument reed is preferably 0.10 mm, and more preferably 0.13 mm. The upper limit of the average thickness of the tip of the vamp is preferably 0.18 mm, and more preferably 0.16 mm. In the case where the average thickness of the tip of the vamp is less than the lower limit, the vamp has insufficient strength, which may lead to a breakage of the vamp during a performance. To the contrary, when the average thickness of tip of the vamp is greater than the upper limit, the flexibility of the vamp may be insufficient.

The woodwind instrument reed contains a liquid crystal polymer as a principal component, and a thermoplastic resin. The woodwind instrument reed contains a layered mineral dispersed in a resin matrix. The liquid crystal polymer and the layered mineral which may be used in the present embodiment may be similar to the liquid crystal polymer and the layered mineral contained in the woodwind instrument reed 1 shown in FIGS. 3 and 4.

The lower limit of the content in the liquid crystal polymer in the woodwind instrument reed is preferably 60% by mass, more preferably 70% by mass, and still more preferably 85% by mass. In the case where the content of the liquid crystal polymer is less than the lower limit, it may be difficult to keep the quality of the woodwind instrument reed constant. The upper limit of the content in the liquid crystal polymer in the woodwind instrument reed is preferably 99% by mass, and more preferably 95% by mass. In the case where the content of the liquid crystal polymer is greater than the upper limit, it may be impossible to ensure that the content of the thermoplastic resin and the layered mineral is sufficiently high.

Examples of the thermoplastic resin include polyethylene, polypropylene, polystyrene, fluorocarbon resins, polycarbonates, polysulfone, poly(ethersulfone), polyacetals, polyethylene terephthalate, polybutylene terephthalate, polyamides, polyimides, acrylonitrile-butadiene-styrene resins, and the like, which may be used either alone, or as a mixture of two or more types thereof. Of these, resins miscible with the liquid crystal polymer are preferred, and polypropylene is particularly preferred, as the thermoplastic resin. The thermoplastic resin miscible with the liquid crystal polymer effectively increases the pliability of the woodwind instrument reed, thereby enabling a further improvement in flexibility of the woodwind instrument reed. Polypropylene has a small specific gravity, and thus, the use of polypropylene as the thermoplastic resin enables the woodwind instrument reed to achieve weight reduction. In addition, the use of polypropylene as the thermoplastic resin enables a reduction in the thickness of the vamp through molding shrinkage of polypropylene in the formation of the woodwind instrument reed by injection molding, thereby further enhancing the flexibility of the vamp. Therefore, the use of polypropylene as the thermoplastic resin enables significant enhancement of the flexibility of the woodwind instrument reed, and of the flexibility of the vamp in particular, leading to a further improved performance quality.

The upper limit of the elastic modulus in flexure of the thermoplastic resin is preferably 3,000 MPa, and more preferably 2,500 MPa, and still more preferably 2,000 MPa. In the case where the elastic modulus in flexure of the thermoplastic resin is greater than the upper limit, the flexibility of the woodwind instrument reed may not be sufficiently enhanced. The lower limit of the elastic modulus in flexure of the thermoplastic resin may be, for example, 400 MPa, but is not limited thereto.

The lower limit of the content of the thermoplastic resin in the woodwind instrument reed is preferably 1% by mass, and more preferably 2% by mass. The upper limit of the content of the thermoplastic resin is preferably 20% by mass, more preferably 10% by mass, still more preferably 5% by mass, and particularly preferably 4% by mass. In the case where the content of the thermoplastic resin is less than the lower limit, the flexibility of the woodwind instrument reed may not be sufficiently enhanced. Conversely, in the case where the content of the thermoplastic resin is greater than the upper limit, it may be difficult to form a woodwind instrument reed into a desired shape and to control the flexibility of the woodwind instrument reed. Specifically, in the case where the content of polypropylene, which may be preferably contained in the woodwind instrument reed as the thermoplastic resin as mentioned above, is greater than the upper limit, molding shrinkage of polypropylene may result in generation of recesses on the back face of the woodwind instrument reed. The generation of such recesses may make it difficult to attach the woodwind instrument reed to the mouthpiece and may lead to leakage of breath through the recesses. Thus, in the case where polypropylene is used as the thermoplastic resin in the formation of the woodwind instrument reed, it is particularly preferred that the content of the thermoplastic resin falls within the above range.

The woodwind instrument reed may contain, in addition to the liquid crystal polymer as a principal component and the thermoplastic resin, other synthetic resins. For controlled flexibility and consistency in quality, however, it is preferred that the woodwind instrument reed does not contain synthetic resins, except for the liquid crystal polymer and the thermoplastic resin.

As mentioned above, the woodwind instrument reed preferably contains the layered mineral in a dispersion state. The layered mineral contained in a dispersion state in the woodwind instrument reed enables an improvement in the filling property of the liquid crystal polymer in the cavity, and thus allows the liquid crystal polymer to be charged into the tip of the cavity easily without fail, leading to improved formability of the woodwind instrument reed. In the case where polypropylene is used as the thermoplastic resin, the thickness of the woodwind instrument reed is likely to vary due to molding shrinkage of polypropylene. However, the layered mineral contained in a dispersion state enables inhibition of the variations in thickness. Thus, the woodwind instrument reed is allowed to contain a relatively large amount of polypropylene when containing the layered mineral in a dispersion state.

The mean particle diameter, the content, the shape and the average aspect ratio of the layered mineral may be similar to those of the woodwind instrument reed 1 shown in FIGS. 3 and 4.

The liquid crystal polymer contained in the woodwind instrument reed is preferably oriented in the longitudinal direction. The liquid crystal polymer oriented in the longitudinal direction imparts further enhanced flexibility to the woodwind instrument reed, thereby enabling a further improvement in quality.

The woodwind instrument reed may contain additives other than the layered mineral.

The method for producing a woodwind instrument reed includes charging a composition for forming the reed into a cavity of a mold. The composition contains a liquid crystal polymer as a principal component, and a layered mineral. The woodwind instrument reed may be produced by using, for example, the injection molding apparatus 11 shown in FIG. 5 according to the procedures similar to the procedures for producing the woodwind instrument reed 1 shown in FIGS. 3 and 4.

### Advantages

The woodwind instrument reed of the second embodiment contains, in addition to the liquid crystal polymer as a principal component, the thermoplastic resin, which enables enhanced flexibility, leading to an improved performance quality.

According to the method for producing a woodwind instrument reed of the second embodiment, the composition for forming the reed contains, in addition to the liquid crystal polymer as a principal component, the thermoplastic resin, which enables the woodwind instrument reed to achieve enhanced flexibility and to provide an enhanced performance quality.

### Other Embodiments

It is to be noted that the woodwind instrument reed and the method for producing a woodwind instrument reed according to the embodiments of the present invention may also be exploited in various modified or altered modes other than those described above.

The composition for forming the reed may be prepared by, for example, mixing the liquid crystal polymer with the layered mineral. Alternatively, the composition may be prepared by mixing the liquid crystal polymer with a composition containing the liquid crystal polymer and the layered mineral. In the case where the composition for forming the reed is prepared by mixing the liquid crystal polymer with the composition containing the liquid crystal polymer and the layered mineral, the woodwind instrument reed is easily patterned due to the liquid crystal polymer and the composition being less miscible with each other.

Although the thermoplastic resin, which may be contained in the woodwind instrument reed, is preferably miscible with the liquid crystal polymer as mentioned above, the thermoplastic resin immiscible with the liquid crystal polymer is acceptable. Even in the case where the woodwind instrument reed contains the thermoplastic resin and the liquid crystal polymer that are immiscible with each other (i.e., the woodwind instrument reed contains a sea phase formed from the liquid crystal polymer and an island phase formed from the thermoplastic resin and dispersed in the sea phase), the thermoplastic resin enables enhanced flexibility.

The specific shape of the vamp is not limited, and the surface of the vamp may be embossed with a predetermined pattern.

It is not always required that the composition for forming the reed is charged into the cavity of the mold through the side gate as in the aforementioned embodiments. According to the method for producing a woodwind instrument reed, the composition may be charged through, for example, a direct gate.

### EXAMPLES

Hereinafter, the embodiments of the present invention will be described in more detail by way of Examples, but the present invention is not in any way limited to the following Examples.

No. 1

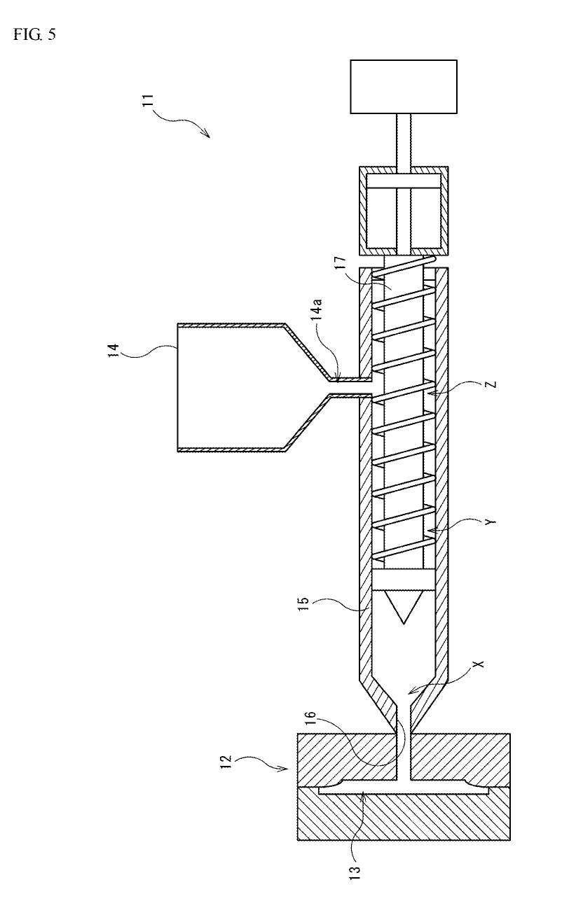

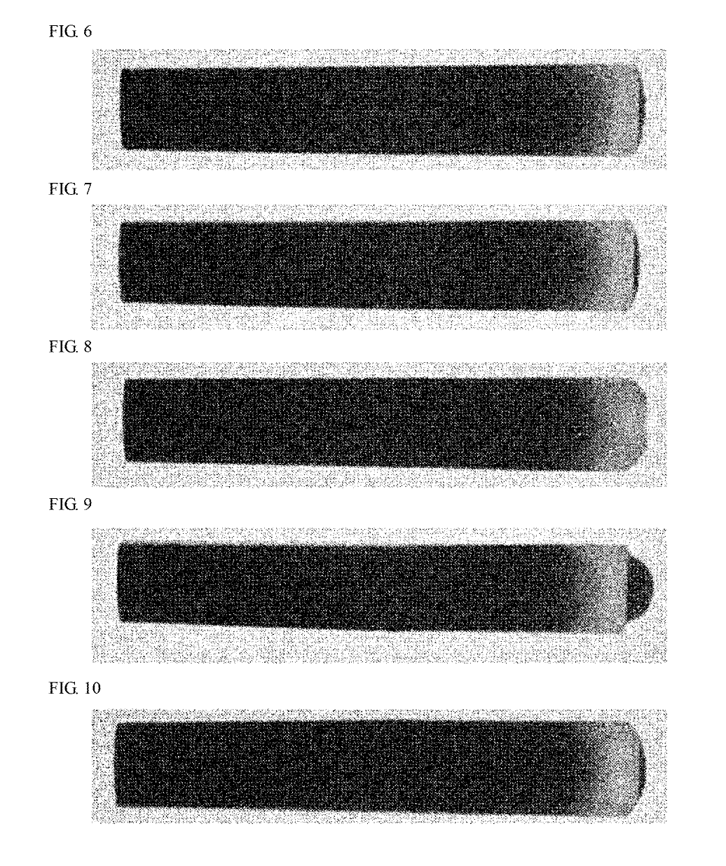

A liquid crystal polymer was mixed with a composition containing the liquid crystal polymer and talc having a mean particle diameter of 10 μm to prepare a composition for forming a reed containing the liquid crystal polymer in an amount of 97.5% by mass and talc in an amount of 2.5% by mass. Then, the composition for forming the reed was charged into the cavity of the mold by using the injection molding apparatus, from the longitudinal end on the side opposite to the vamp to be formed. When the composition for forming the reed was charged, each of the temperatures was regulated as follows: 300° C. in the nozzle of the cylinder and in the front part of the cylinder; 280° C. in the intermediate part of the cylinder; 190° C. in the rear part of the cylinder; and 70° C. at the inlet of the hopper. When the composition for forming the reed was charged, the temperature in the cavity was 70° C., the injection speed of the composition for forming the reed was 150 mm/s, and switchover to maintaining pressure took place at 3.96 mm. Subsequently, the pressure in the cavity was maintained for 7.5 seconds, and then the cavity was cooled for 25 seconds to harden the composition for forming the reed, which was thereafter released from the cavity. In this way, the No. 1 woodwind instrument reed was obtained, the average length of which in the longitudinal direction was 71 mm. The average length of the vamp in the longitudinal direction was 25 mm, and the average thickness of the tip of the vamp was 0.1 mm. FIG. 6 is a photographed image of a plane surface of the No. 1 woodwind instrument reed removed from the injection molding apparatus.

No. 2

The liquid crystal polymer was mixed with a composition containing the liquid crystal polymer and talc having a mean particle diameter of 10 μm to prepare a composition for forming a reed containing the liquid crystal polymer in an amount of 95% by mass and talc in an amount of 5% by mass. The composition for forming the reed was subjected to injection molding under conditions similar to the conditions where the composition for forming the No. 1 reed was produced, whereby the No. 2 woodwind instrument reed was obtained, the average length of which in the longitudinal direction was 71 mm. The average length of the vamp in the longitudinal direction was 25 mm, and the average thickness of the tip of the vamp was 0.1 mm. FIG. 7 is a photographed image of a plane surface of the No. 2 woodwind instrument reed removed from the injection molding apparatus.

No. 3

The liquid crystal polymer was mixed with a composition containing the liquid crystal polymer, and talc having a mean particle diameter of 10 μm to prepare a composition for forming a reed containing the liquid crystal polymer in an amount of 99% by mass and talc in an amount of 1% by mass. The composition for forming the reed was subjected to injection molding under conditions similar to the conditions where the composition for forming the No. 1 reed was produced, whereby the No. 3 woodwind instrument reed was obtained, the average length of which in the longitudinal direction was 71 mm. The average length of the vamp in the longitudinal direction was 25 mm, and the average thickness of the tip of the vamp was 0.1 mm. FIG. 8 is a photographed image of a plane surface of the No. 3 woodwind instrument reed removed from the injection molding apparatus.

No. 4

The liquid crystal polymer was mixed with a composition containing the liquid crystal polymer and talc having a mean particle diameter of 10 μm to prepare a composition for forming a reed containing the liquid crystal polymer in an amount of 90% by mass and talc in an amount of 10% by mass. The composition for forming the reed was subjected to injection molding under conditions similar the conditions where the composition for forming the No. 1 reed was produced, whereby the No. 4 woodwind instrument reed was obtained, the average length of which in the longitudinal direction was 71 mm. The average length of the vamp in the longitudinal direction was 25 mm, and the average thickness of the tip of the vamp was 0.1 mm. FIG. 9 is a photographed image of a plane surface of the No. 4 woodwind instrument reed removed from the injection molding apparatus.

No. 5

A composition for forming a reed containing the liquid crystal polymer in an amount of 100% by mass was prepared. The composition for forming the reed was subjected to injection molding under conditions similar to the conditions where the composition for forming the No. 1 reed was produced, whereby the No. 5 woodwind instrument reed was obtained, the average length of which in the longitudinal direction was 71 mm. The average length of the vamp in the longitudinal direction was 25 mm, and the average thickness of the tip of the vamp was 0.15 mm. FIG. 10 is a photographed image of a plane surface of the No. 5 woodwind instrument reed removed from the injection molding apparatus.

Vibration Modes

FIG. 11 shows vibration modes of the Nos. 1, 2, 4 and 5 woodwind instrument reeds. FIG. 11 suggests that the frequency and the speed level increased with increasing talc content. It is inferred that talc per se imparted greater rigidity to the Nos. 1, 2 and 4 woodwind instrument reeds and that due to talc contained, the rigidity was increased in such a manner that the liquid crystal polymer was oriented even in the tip portion of the vamp.

### Evaluation Results

As mentioned above, the average thickness of the tip of the vamp of each of the No. 1 to No. 4 woodwind instrument reeds was smaller than the average thickness of the tip of the vamp of the No. 5 woodwind instrument reed. Thus, the No. 1 to No. 4 woodwind instrument reeds have enhanced flexibility as compared to the No. 5 woodwind instrument reed.

Unlike the No. 5 woodwind instrument reed, the No. 1 to No. 4 woodwind instrument reeds were formed in such a manner that the liquid crystal polymer was charged even to the tip portion of the vamp and that the liquid crystal polymer was oriented in the longitudinal direction even in the tip portion of the vamp as shown in FIGS. 6 to 10. (The regions in FIGS. 6 to 10 correspond to regions in which the liquid crystal polymer was oriented in the longitudinal direction.) It is inferred that due to talc contained, the slipping property of the liquid crystal polymer in the cavity was improved and thus the liquid crystal polymer in a molten state was sufficiently charged even into the tip portion of the vamp. FIGS. 6 to 9 also indicate that among the Nos. 1 to 4 woodwind instrument reeds, No. 1 having a talc content of 2.5% by mass and No. 2 having a talk content of 5% by mass yielded orientation of the liquid crystal polymer in the longitudinal direction over a region closer to the tip portion of the vamp as compared to No. 3 having a talc content of 1% by mass and No. 4 having a talc content of 10% by mass. It is inferred that increasing the talc content to some extent is more likely to improve the slipping property of the liquid crystal polymer in the cavity, but the liquid crystal polymer would have a low degree of orientation due to talc in the case where the talc content is excessively high. Thus, as shown in FIG. 11, the rigidity of the woodwind instrument reed as a whole increases with increasing talc content, resulting in a higher frequency and a higher speed level. The tip portion of the vamp of the No. 4 woodwind instrument reed is not sufficiently rigid as compared to the tip portion of the vamp of each of the No. 1 and 2 woodwind instrument reeds, and may be brittle and breakable, thereby being likely to cause discomfort for the player. In contrast, the liquid crystal polymer sufficiently oriented in the region closer to the tip of the vamp enables the No. 1 and 2 woodwind instrument reeds to provide a tactile sense similar to that provided by high-quality reeds formed from, for example, phragmites.

No. 6

A composition for forming a reed containing the liquid crystal polymer (“A8100” available from Ueno Fine Chemicals Industry, Ltd.) in an amount of 98% by mass and polypropylene (“BC03B” available from Japan Polypropylene Corporation) in an amount of 2% by mass was prepared. Then, the composition for forming the reed was charged into the cavity of the mold by using the injection molding apparatus, from the longitudinal end on the side opposite to the vamp to be formed. When the composition for forming the reed was charged, each of the temperatures was regulated as follows: 300° C. in the nozzle of the cylinder and in the front part of the cylinder; 280° C. in the intermediate part of the cylinder; 190° C. in the rear part of the cylinder, and 70° C. at the inlet of the hopper. When the composition for forming the reed was charged, the temperature in the cavity was 70° C., the injection speed of the composition for forming the reed was 150 mm/s, and switchover to maintaining pressure took place at 3.96 mm. Subsequently, the pressure in the cavity was maintained for 7.5 seconds, and then, the cavity was cooled for 25 seconds to harden the composition for forming the reed, which was thereafter released from the cavity. In this way, the No. 6 woodwind instrument reed was obtained, the average length of which in the longitudinal direction was 71 mm. The average length of the vamp in the longitudinal direction was 25 mm, and the average thickness of the tip of the vamp was 0.12 mm.

No. 7

The No. 7 woodwind instrument reed was obtained in a similar manner to the No. 6 woodwind instrument reed except that the content of the liquid crystal polymer was 96% by mass and the content of polypropylene was 4% by mass. The average length of the No. 7 woodwind instrument reed in the longitudinal direction was 71 mm. The average length of the vamp in the longitudinal direction was 25 mm, and the average thickness of the tip of the vamp was 0.13 mm.

No. 8

A composition for forming a reed containing the liquid crystal polymer (“A8100” available from Ueno Fine Chemicals Industry, Ltd.) in an amount of 93% by mass, polypropylene (“BC03B” available from Japan Polypropylene Corporation) in an amount of 2% by mass, and talc (“MICRO ACE K-1” available from Nippon Talc Co., Ltd.) in an amount of 5% by mass the mean particle diameter of which was 3.2 μm was prepared. The composition for forming the reed was subjected to injection molding under conditions similar to the conditions where the composition for forming the No. 6 reed was produced, whereby the No. 8 woodwind instrument reed was obtained, the average length of which in the longitudinal direction was 71 mm. The average length of the vamp in the longitudinal direction was 25 mm, and the average thickness of the tip of the vamp was 0.15 mm.

No. 9

The No. 9 woodwind instrument reed was obtained in a similar manner to the No. 6 woodwind instrument reed except that the content of the liquid crystal polymer was 91% by mass, the content of polypropylene was 4% by mass, and the content of talc was 5% by mass. The average length of the No. 9 woodwind instrument reed in the longitudinal direction was 71 mm, the average length of the vamp in the longitudinal direction was 25 mm, and the average thickness of the tip of the vamp was 0.15 mm.

No. 10

The No. 10 woodwind instrument reed was obtained in a similar manner to the No. 6 woodwind instrument reed except that the content of the liquid crystal polymer was 89% by mass, the content of polypropylene was 6% by mass, and the content of talc was 5% by mass. The average length of the No. 10 woodwind instrument reed in the longitudinal direction was 71 mm, the average length of the vamp in the longitudinal direction was 25 mm, and the average thickness of the tip of the vamp was 0.12 mm.

No. 11

The No. 11 woodwind instrument reed was obtained in a similar manner to the No. 6 woodwind instrument reed except that the content of the liquid crystal polymer was 87% by mass, the content of polypropylene was 8% by mass, and the content of talc was 5% by mass. The average length of the No. 11 woodwind instrument reed in the longitudinal direction was 71 mm, the average length of the vamp in the longitudinal direction was 25 mm, and the average thickness of the tip of the vamp was 0.12 mm.

No. 12

The No. 12 woodwind instrument reed was obtained in a similar manner to the No. 6 woodwind instrument reed except that the content of the liquid crystal polymer was 83% by mass, the content of polypropylene was 12% by mass, and the content of talc was 5% by mass. The average length of the No. 12 woodwind instrument reed in the longitudinal direction was 71 mm, the average length of the vamp in the longitudinal direction was 25 mm, and the average thickness of the tip of the vamp was 0.12 mm.

No. 13

The No. 13 woodwind instrument reed was obtained in a similar manner to the No. 6 woodwind instrument reed except that the content of the liquid crystal polymer was 75% by mass, the content of polypropylene was 20% by mass, and the content of talc was 5% by mass. The average length of the No. 13 woodwind instrument reed in the longitudinal direction was 71 mm, the average length of the vamp in the longitudinal direction was 25 mm, and the average thickness of the tip of the vamp was 0.12 mm.

No. 14

A composition for forming a reed containing the liquid crystal polymer (“A8100” available from Ueno Fine Chemicals Industry, Ltd.) in an amount of 100% by mass was subjected to injection molding under conditions similar to the conditions where the composition for forming the No. 6 reed was produced, whereby the No. 14 woodwind instrument reed was obtained, the average length of which in the longitudinal direction was 71 mm. The average length of the vamp in the longitudinal direction was 25 mm, and the average thickness of the tip of the vamp was 0.18 mm.

No. 15

A composition for forming a reed containing the liquid crystal polymer (“A8100” available from Ueno Fine Chemicals Industry, Ltd.) in an amount of 95% by mass and talc (“MICRO ACE K-1” available from Nippon Talc Co., Ltd.) in an amount of 5% by mass the mean particle diameter of which was 3.2 μm was prepared. The composition for forming the reed was subjected to injection molding under conditions similar to the conditions where the composition for forming the No. 6 reed was produced, whereby the No. 15 woodwind instrument reed was obtained, the average length of which in the longitudinal direction was 71 mm. The average length of the vamp in the longitudinal direction was 25 mm, and the average thickness of the tip of the vamp was 0.17 mm.

Molding Shrinkage Rate

The molding shrinkage rate (%) of each of the No. 6 to No. 15 woodwind instrument reeds in the thickness direction was determined by using a digital height gage. The results of the determination are shown in Table 1.

Playing Comfort

In accordance with the following criteria, the No. 6 to No. 15 woodwind instrument reeds were evaluated for playing comfort in such a manner that each of the No. 6 to No. 15 woodwind instrument reeds was attached to a mouthpiece fitted in a saxophone and the player blew into the mouthpiece. The results of the evaluation are shown in Table 1.

A: light with ease of blowing

B: slightly heavy

C: heavy with reduced ease of blowing

TABLE 1

| | No. 6 | No. 7 | No. 8 | No. 9 | No. 10 | No. 11 | No. 12 | No. 13 | No. 14 | No. 15 |
|---|---|---|---|---|---|---|---|---|---|---|
| Molding | 2.53 | 3.80 | 0.75 | 0.76 | 3.02 | 3.53 | 4.03 | 4.76 | 0 | 0 |
| Shrinkage | | | | | | | | | | |
| Rate (%) | | | | | | | | | | |
| Playing | B | B | A | A | B | B | B | B | C | C |
| Comfort | | | | | | | | | | |

Elastic Modulus in Flexure

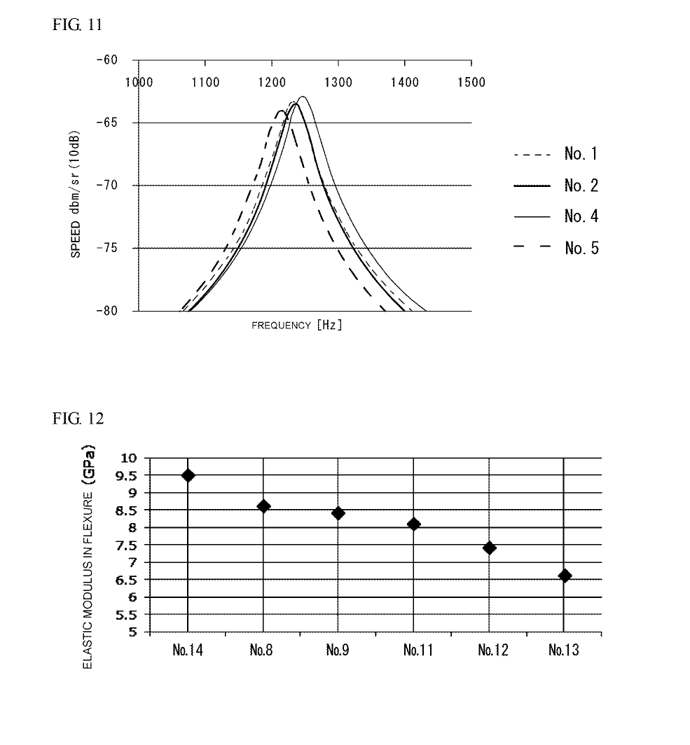

The elastic modulus in flexure (GPa) of each of the Nos. 8, 9, 11 to 14 woodwind instrument reeds was determined in accordance with JIS-K7171: 2008. Specifically, by using “Model 5967” available from Instron, three-point bending tests were carried out under conditions involving a support span of 20 mm and a cross-head speed of 5 mm/min for determination of the elastic modulus in flexure of each of the Nos. 8, 9, 11 to 14 woodwind instrument reeds. The results of the determination are shown in FIG. 12.

Weight

The weight (g) of each of the Nos. 8, 9, 11 to 14 woodwind instrument reeds was determined by using an electronic balance. The results of the determination are shown in Table 2.

Bendability

Cantilever bending tests were carried out to determine the load (N) required to bend each of the Nos. 8, 12 and 13 woodwind instrument reeds in a manner to shift the position of the reed portion 7 mm apart from its tip, by 1.5 mm. The results of the determination are shown in Table 2.

TABLE 2

| | No. 8 | No. 9 | No. 11 | No. 12 | No. 13 | No. 14 |
|---|---|---|---|---|---|---|
| Weight (g) | 2.88 | 2.78 | 2.72 | 2.63 | 2.52 | 3.02 |
| Load (N) | 1.7 | — | — | 1.6 | 1.2 | — |

### Evaluation Results

As shown in Table 1, the No. 6 to No. 13 woodwind instrument reeds that contained the liquid crystal polymer and polypropylene were proven to have enhanced flexibility, thereby providing improved playing comfort, as compared to the No. 14 and 15 woodwind instrument reeds with no polypropylene contained. When the Nos. 6 and 8 woodwind instrument reeds having the same polypropylene content and the Nos. 7 and 9 woodwind instrument reeds having the same polypropylene content were compared, the Nos. 8 and 9 woodwind instrument reeds that contained talc each had a reduced molding shrinkage rate, which resulted from polypropylene, thus exhibiting improved shape stability, as compared to the Nos. 6 and 7 woodwind instrument reeds with no talc contained. These results reveal that the Nos. 8 and 9 woodwind instrument reeds respectively containing, in addition to talc, polypropylene in an amount of 2% by mass and polypropylene in an amount of 4% by mass achieved shape stability while the tip of the vamp had a reasonably small average thickness due to molding shrinkage of polypropylene, thus enabling the vamp to have enhanced flexibility and providing notably enhanced playing comfort accordingly.

As shown in FIG. 12, the woodwind instrument reed having a higher polypropylene content had a smaller elastic modulus in flexure, and exhibited superior flexibility accordingly. Furthermore, as shown in Table 2, the woodwind having a higher polypropylene content was more lightweight. It is inferred that reductions in weight would result in improved vibration characteristics. Also as shown in Table 2, the reed having a higher polypropylene content was more bendable (i.e., a smaller load was required to bend the tip of the reed having a higher polypropylene content), and thus, adjusting the polypropylene content in a woodwind instrument reed can extend range of choices including, for example, No. 8 as the reed of the fourth order, No. 12 as the reed of the third order, and No. 13 as the reed of the second order.

### INDUSTRIAL APPLICABILITY

As described above, the use of the liquid crystal polymer in the formation of the woodwind instrument reed according to the embodiments of the present invention enables a reduction in the thickness of the tip of the vamp even through the use of a liquid crystal polymer, and accordingly enables the vamp to have enhanced flexibility. Therefore, the woodwind instrument reed may be applicable not only to saxophones but also other various woodwind instruments to be provided with a reed.

### DESCRIPTION OF THE REFERENCE SYMBOLS

1: woodwind instrument reed

2: saxophone body

3: mouthpiece

4: pipe part

5: key

6: lever

7: ligature

8: vamp

9: front face

11: injection molding apparatus

12: mold

13: cavity

14: hopper

14a: inlet

15: cylinder

16: nozzle

17: screw

X: front part

Y: intermediate part

Z: rear part

What is claimed is:

1. A woodwind instrument reed that is strip-shaped and has a vamp on one side in a longitudinal direction, the woodwind instrument reed comprising:
a resin matrix comprising a liquid crystal polymer as a principal component; and
a layered mineral dispersed in the resin matrix.

2. The woodwind instrument reed according to claim 1, wherein a content of the layered mineral is 1% by mass or more and 5% by mass or less.

3. The woodwind instrument reed according to claim 1, wherein a mean particle diameter of the layered mineral is 5 μm or more and 20 μm or less.

4. The woodwind instrument reed according to claim 1, wherein the layered mineral is talc.

5. The woodwind instrument reed according to claim 1, wherein the liquid crystal polymer is oriented in the longitudinal direction.

6. The woodwind instrument reed according to claim 1, further comprising a thermoplastic resin.

7. The woodwind instrument reed according to claim 6, wherein the thermoplastic resin is miscible with the liquid crystal polymer.

8. The woodwind instrument reed according to claim 6, wherein the thermoplastic resin is polypropylene.

9. The woodwind instrument reed according to claim 6, wherein a content of the thermoplastic resin is 1% by mass or more and 20% by mass or less.

10. A method for producing a woodwind instrument reed that is strip-shaped and has a vamp on one side in a longitudinal direction, the method comprising:
charging a composition for forming the reed into a cavity of a mold from a longitudinal end on a side opposite to the vamp to be formed, the composition comprising a liquid crystal polymer as a principal component, and a layered mineral.
